(19) United States
(12) Patent Application Publication
(10) Pub. No.: US 2010/0260535 A1
(43) Pub. Date: Oct. 14, 2010

(54) Vertical Doucment Holder

(76) Inventor: Mark Brown, Rolling Hills Estates, CA (US)

Correspondence Address: John Alumit, 16830 Ventura Blvd. Suite 360, Encino, CA, 91436, US

(21) Appl. No.: 12/420,707

(22) Filed: Apr. 8, 2009

(51) Int. Cl. B42F 3/00

(52) U.S. Cl. 402/70

(57) ABSTRACT

The present invention comprises a document holder for placement on a vertical surface, comprising a backplate and a ring binder mechanism anchored to the backplate using standard anchoring means, the backplate having a surface area at least twice the size of the ring binder mechanism to provide sufficient leverage for the document holder to be placed on a vertical surface utilizing means other than nails or screws, and that do not damage the vertical surface, including by means of tacks or pushpins, adhesive strips, magnetic backing, or hook and loop-type fasteners (Velco®).

### CROSS-REFERENCE TO RELATED APPLICATION

Not Applicable

### FEDERALLY SPONSORED RESEARCH

Not Applicable

SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention generally relates to ring-binders and specifically to ring-binders used to display documents on vertical surfaces.

Ring binder mechanisms are well known in the art. For example, U.S. Pat. No. 5,842,807 discloses a ring binder adapted to be secured to an article by at least one integral rivet, the ring binder comprising a substantially rigid integral upper plate supporting a pair of pivotal lower plates to which a plurality of ring members are mounted, the rivet comprising (1) a barrel that is in direct engagement with the upper plate and (2) a plurality of claws for securing the article, wherein at least 75% of said claws extend away from a longitudinal axis of the barrel. Also disclosed is a rivet adapted to secure a ring binder to an article, the rivet comprising (1) a barrel for engaging the ring binder and (2) a plurality of claws for securing the article, wherein at least a majority of the claws generally extend away from a longitudinal axis of the barrel.

The article to which the rivet is attached into is normally a folder or binder placed on a horizontal surface. However, it is often desirable to prominently display numerous documents on bulletin boards, walls and other vertical surfaces and do so in an organized fashion using substantially less space.

While it may be conceivable to attach a ring binder mechanism to a bulletin board, wall, etc., to do so is not practical because it would require nails, screws or other permanent attachment. This would damage the surface being attached to and would not allow for portability in displaying documents.

Moreover, it may not be desirable to permanently place a ring binder mechanism to the vertical surface. For example, bulletin boards utilize tacks or pushpins for temporary display of documents. In these instances, only tacks or pushpins may be utilized to display documents. Given the design of a binder mechanism, tacks would not be long enough to pass through the rivet holes or be strong enough to hold the ring binder mechanism onto a vertical surface.

It is therefore the object of the present invention to solve the problem of disorganization, space consumption, damage to documents, and wall damage caused by displaying multiple documents on bulletin boards, walls or other vertical surfaces. This invention (Vertical Document Holder) can be attached to a variety of vertical surfaces using either pushpins, magnetic, adhesive or hook and loop-type fasteners (velcro©) backing strips. This device will allow as many as 25 documents to be organized and displayed in an efficient manner at the same time reducing space dramatically.

### SUMMARY

The present invention comprises a vertical document holder. The vertical document holder comprises a backplate and a ring binder mechanism with standard anchoring means for fixing the ring binder mechanism to the front surface of the backplate, the backplate being at least twice the width of the ring binder mechanism and having a means for attaching the backplate to a vertical surface, including tacks or pushpins inserted through at least two holes on the back plate, hook and loop-type fasteners (Velcro®), adhesive, or magnetic backing. In this way, no damage is done to the vertical surface or to the documents, and multiple documents can be prominently and systematically displayed on bulletin boards, walls or other vertical surfaces. The present invention can store as many as 25 documents in the space normally required for one document dramatically reducing space requirements.

### BRIEF DESCRIPTION OF THE FIGS.

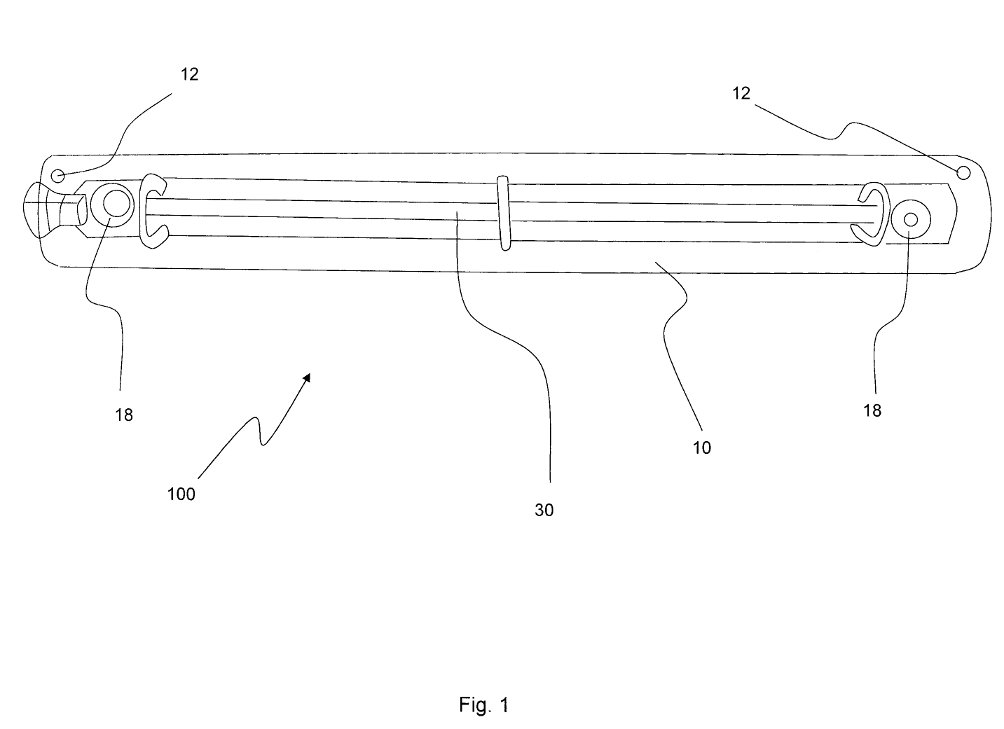

FIG. 1 is a front view of a vertical document holder having three rings.

### DETAILED DESCRIPTION

Referring to FIG. 1, a vertical document holder is shown and described. The holder 100 comprises a ring binder mechanism 30 with at least one rivet 18 to anchor the ring binder mechanism 30 onto a backplate 10. A preferred embodiment of the invention is to have at least two holes 12 on the backplate 10 upper portion for insertion of tacks or pushpins against a vertical surface. The backplate is at least twice the width of the ring binder mechanism to provide sufficient leverage for vertical document holder to be supported on a wall with the use of tacks or pushpins, hook and loop-type fasteners (Velcro®), adhesives strips, or magnetic backing. As many as 25 documents can be supported in this manner.

In lieu of the two holes 12, Hook and loop-type fasteners, adhesive strips, or magnetic backing [not shown] are provided for placement on the back surface of the backplate 10 when the vertical document holder is placed on a hard or metallic surface.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A document hanging article, comprising a backplate wherein a binder mechanism is disposed on the front surface to retain documents, and wherein the back surface contacts a vertical surface; the backplate having a surface area at least twice the size of the binder mechanism, and that can be attached to a vertical surface, without the use of screws or nails, by utilizing means that do not damage the vertical surface, including by means of tacks or pushpins, hook and loop-type fasteners (Velcro®), adhesives strips, or magnetic backing; the binder mechanism comprising means for anchoring the binder mechanism to the backplate.

2. The article of claim 1, wherein the backplate comprises at least two holes with sufficient circumference for insertion of tacks or pushpins, wherein at least one hole is disposed on the upper portion of the backplate.

3. The article of claim 1, wherein the means for anchoring comprises at least one rivet inserted through the binder mechanism and backplate.
